(19) United States
(12) Patent Application Publication
(10) Pub. No.: US 2016/0241709 A1
(43) Pub. Date: Aug. 18, 2016

(54) VIRTUAL ARS DATA CONTROL SYSTEM USING MOBILE TERMINAL AND METHOD THEREFOR

(71) Applicants: Se-yong Lee, Seoul (KR); TW MOBILE CO., LTD, Seocho-gu, Seoul (KR)

(72) Inventors: Se-yong Lee, Seoul (KR); Kyo-sik Hong, Ansung (KR); Hyun-Joo Jeon, Cheoin (KR)

(21) Appl. No.: 15/030,659

(22) PCT Filed: Oct. 20, 2014
(86) PCT No.: PCT/KR2014/009846

§ 371 Date: Apr. 20, 2016

(30) Foreign Application Priority Data
Oct. 21, 2013 (KR) 10-2013-0125524
Oct. 10, 2014 (KR) 10-2014-0137001

(51) Int. Cl. H04M 1/725; G06F 3/0482; H04M 3/523; G06F 3/16; H04M 3/51; H04W 4/16; G06F 3/0484

(52) U.S. Cl. CPC H04M 1/72583; H04W 4/16; G06F 3/0482; G06F 3/04842; G06F 3/16; H04M 3/5108; H04M 3/5235

(57) ABSTRACT

The present invention provides a system and a method for controlling virtual ARS data using a mobile terminal. The system and the method for controlling virtual ARS data using a mobile terminal is capable of effectively reducing communication traffic without ARS construction costs or ARS counselors by downloading second-ranking screen data and voice data to a customer phone while matching each of the screen data with each of the voice data depending on a key selection of a customer to automatically output the screen data and the voice data, so as to provide an ARS service while a communication connection is released, and by allowing an application to automatically transmit ARS service information of the customer to a designated server or a designated terminal of the company when the ARS service performed by the customer's mobile terminal ends.

### TECHNICAL FIELD

The present invention relates to a system for controlling virtual automatic response service (ARS) data using a mobile terminal and a method thereof, and more particularly, to a system and a method for controlling virtual ARS data using a mobile terminal, in which virtual ARS packet data including voice and screen data are downloaded when a customer accesses a virtual ARS service of a specific company using a mobile application, the customer may use the ARS service while a communication connection is released, and ARS input information of the customer is automatically transmitted to the company when the service ends.

### BACKGROUND ART

With the recent development of information communication technologies, information providing technologies which provide information on various fields to multiple subscribers through at least one host server via a long-distance data communication network in real time has been actively realized.

Based on the information providing technologies, in particular, the technology development of a mobile terminal field is rapidly in progress.

With the advancement of industry, providing an answer to various customer query sentences before sale of products, during delivery of products, and after sale of products and information on the customer query sentences by reinforcing a service system for sale of products is also a part of the important marketing, which has a great effect on sales of selling companies. However, since the selling companies need to hire many counselors, there is a problem in that they pay a lot of labor costs.

In particular, financial companies, or the like need to answer many questions of users. Similarly, however, the financial companies may not hire many counselors due to economical grounds, and therefore, when the users select a pre-programmed path using an ARS service, automatically extract and output the answers.

However, the financial companies not only spend a lot of costs to construct the automatic response service (ARS), but also hire separate ARS personnel or ask professional ARS counseling companies ARS counseling while paying them.

A main content of the ARS counseling is about a new product, a service related question, an A/S related question, or the like. However, medium and small-sized enterprises having a small sales volume of products may little obtain an economic effect through the ARS, and therefore there is a problem in that it is difficult for the medium and small-sized enterprises to ask the professional ARS counseling companies the ARS counseling.

Further, the ARS personnel is not a researcher or a staff of the company, and therefore previously gets responses corresponding to expected questions of a customer from the company to simply answer questions of a customer based on the responses. Therefore, there is a problem in that it is difficult for the ARS personnel to answer difficult questions. Accordingly, in this case, it is common that the ARS personnel just takes the question while promising to provide the answer to the questing later on.

For all that, when a staff or a researcher of the company intends to directly do phone counseling, he or she needs listen to all the questions from the beginning, and therefore consult about all the contents such as acceptance or change of simple information and reservation one by one. Therefore, there are no economic benefits.

However, in a case of using an ARS system, the user may not rapidly enter his or her desired items and may not determine what the user desired item number is until he or she listens to voices output from a receiver one by one.

Further, if the ARS service is provided to the hearing-impaired person, the aged, or the like having reduced hearing ability or places where the surroundings are noisy, there is a problem in that the ARS service may not smoothly provided.

Therefore, a method for allowing a user to receive an ARS service through a screen while reading the screen provided by a server with a user phone accessing the server through a wireless Internet may be considered.

In this case, all the ARS providers need to include a system which may provide the ARS service on the screen through the wireless Internet, and therefore have to pay a lot of costs.

That is, servers should be constructed to enable the user terminal to access a web server temporally linked with an ARS server while accessing the ARS server through a voice communication network, and therefore the ARS providers need to pay a lot of costs.

Further, the user terminal needs to simultaneously access the ARS server and the web server, and therefore an increase in traffic is inevitable. That is, the user terminal needs to keep on accessing the server providing the ARS screen while he or she receives the ARS service through the screen, and therefore the increase in traffic is inevitable.

In particular, if the number of users is suddenly increased, line traffic for keeping a simultaneous access to a plurality of phones is very large, and therefore the server is highly likely to be down. Further, when the ARS providers increase a server capacity to stably operate the server, there is a problem in that the economic burden of the ARS providers is increased.

Meanwhile, as the search frequency of the Internet with the mobile terminal is getting increased recently, the ARS providers need to separately manufacture mobile home pages or mobile web pages and perform operations such as updating the mobile pages, which also puts a huge financial burden on the ARS providers.

Furthermore, even when the voice ARS system is constructed, the number of ARS counselors is limited on the grounds of labor costs, and therefore when the user tries to consult the ARS counselor, there is a problem in that the user has to wait a long time. It has been known that users who wait counselors for a long time and then are not very satisfied with the ARS services provided by the counselors are many.

### DISCLOSURE

### Technical Problem

In consideration of the above-mentioned circumstances, it is an object of the present invention to provide a system and a method for controlling virtual ARS data using a mobile terminal capable of effectively reducing communication traffic without ARS construction costs or ARS counselors by downloading second-ranking screen data and voice data to a customer terminal while matching each of the screen data with each of the voice data depending on a key selection of a customer to automatically output the screen data and the voice data, so as to provide an ARS service while a communication connection is released, and by allowing an application to automatically transmit ARS service information of the customer to a designated server or a designated terminal of the company when the ARS service performed by the customer's mobile terminal ends.

Another object of the present invention is to provide a system and a method for controlling virtual ARS data using a mobile terminal capable of effectively reducing a waiting time of a user and reducing traffic of an ARS server for waiting counseling by allowing a server to automatically operate a counseling waiting time when a user generates a key signal for connecting to a counselor while a screen composite virtual ARS service is progressed, transmit phone number information of a specific staff terminal of a company if it is determined that the waiting time is a preset time or more, and transmit virtual ARS progress history information to a counselor terminal or a designated staff terminal to be called, thus to generate an automatic call attempt.

### Technical Solution

In order to accomplish the above-described objects, according to one aspect of the present invention, there is provided a system for controlling ARS data using a mobile terminal, including: a user terminal 2 configured to generate a virtual ARS service request signal for a specific company to a virtual ARS data management server 50, receive screen composite virtual ARS data 54 combined to have a plurality of selection paths from the virtual ARS data management server 50 to automatically release a connection, and process the virtual ARS service using a key selection signal of a user in an off line state; the virtual ARS data management server 50 configured to receive and register the screen composite virtual ARS data 54 from a plurality of company terminals 18, and extract and download the screen composite virtual ARS data 54 of the company according to a request of the user terminal 2; and a designated company terminal (or a server) 64 configured to receive processing information of the virtual ARS service from the user terminal 2 when the virtual ARS services of each user ends.

Preferably, the screen composite virtual ARS data 54 further includes: data in which a plurality of voice data and web screen data having the same content as the voice data are formed in a tree structure, wherein data to be output in a second ranking are connected to each other so as to be determined depending on a selection key signal of the user for preceding data; and phone number information of the designated company terminal.

Preferably, the user terminal 2 is configured to temporarily store processing information of the virtual ARS service, and automatically transmit the processing information to the designated company terminal (or the server) when the virtual ARS service ends.

Preferably, the user terminal 2 includes: a search window 6 configured to search for companies stored in the virtual ARS data management server 50; and a virtual ARS application 20 configured to output a screen composite virtual ARS service request button 16 for requesting a download of the screen composite virtual ARS data 54 of the company on a screen.

Preferably, the virtual ARS data management server 50 further includes: a data storing unit 52 configured to store the screen composite virtual ARS data 54 for each company, data output path control information, and designated counseling staff phone number information 56.

Preferably, an output of voice data 60a, 60b, 60c and . . . , and an output of screen data 58a, 58b, 58c and . . . having the same content as the voice data, which are included in the screen composite virtual ARS data 54, are synchronized with each other.

Preferably, the virtual ARS data management server 50 is connected to a plurality of ARS counselor terminals 70 to check presence and absence of communication and operate a counseling waiting time.

Preferably, the virtual ARS data management server 50 is connected to a plurality of ARS counselor terminals 70 to check presence and absence of communication to operate a counseling waiting time, and if the waiting time is a preset time or more, the virtual ARS data management server 50 is configured to request information on whether the composite virtual ARS service of any company is progressed to the user terminal 2, and automatically transmit phone number information of a designated counseling staff terminal 72 of the company to the user terminal 2.

Preferably, when the user performs voice counseling with an ARS counselor or designated counseling staffs for each company, the virtual ARS data management server 50 is configured to transmit composite virtual ARS service progress history information of a specific company progressed by the user to an ARS counselor terminal 70 or a designated counseling staff terminal 72.

Preferably, the user terminal 2 includes: a communication module 22 configured to communicate with the virtual ARS data management server 50 and the designated company terminal 64; a screen composite virtual ARS data packet receiving unit 24 configured to receive a screen composite virtual ARS data packet of a specific company from the virtual ARS data management server 50; a data separation unit 26 configured to separate the received screen composite virtual ARS data packet into the voice data and the screen data, data output path control information, and phone number information of the designated company terminal; a key selection monitoring unit 28 configured to monitor a key selection signal of the user when performing the virtual ARS service; a matching data extraction unit 30 configured to extract second-ranking voice data matched with the key selection signal applied by the key selection monitoring unit 28 and the screen data connected to the voice data; a screen/voice output controller 32 configured to output and control the voice data and the screen data extracted by the matching data extraction unit 30; a data storing unit 40 configured to store the data received by the screen composite virtual ARS data packet receiving unit 24 and the data output path control information, and store a key selection signal of the user for the data; and a controller 42 configured to request and receive the screen composite virtual ARS data packet of the specific company from the virtual ARS data management server 50, and control the output of the screen composite virtual ARS data based on the data output path control information.

Preferably, the system further includes: a key selection information storing unit 34 configured to store the information matched with all the key selection signals received by the key selection monitoring unit 28; and a key selection information transmission unit 36 configured to transmit the key selection information to the previously designated company terminal 64.

Preferably, the system further includes: an automatic calling unit 38 configured to automatically perform a phone call on a phone number of the previously designated company terminal 64, when the key selection monitoring unit 28 receives a key signal for requesting a counselor connection.

In order to accomplish the above-described objects, according to another aspect of the present invention, there is provided a method for controlling virtual ARS data using a mobile terminal, including: a) receiving, by a virtual ARS data management server 50, a search request signal for a specific company from a user terminal 2; b) extracting, by the virtual ARS data management server 50, a virtual ARS data packet of the company; c) transmitting, by the virtual ARS data management server 50, the virtual ARS data packet to the user terminal 2, and automatically releasing a communication connection to the user terminal 2; d) outputting voice data and screen data included in the virtual ARS data packet; e) receiving, by the user terminal 2, a specific key selection signal; f) extracting, by the user terminal 2, the voice data and the screen data matched with the key selection signal; g) determining whether a virtual ARS service ending signal is applied; and h) transmitting, by the user terminal 2, key selection information of the user to a designated company terminal 64 included in the virtual ARS data packet when receiving the virtual ARS service ending signal or a counselor connection signal.

Preferably, the method further includes: prior to the step a), downloading and installing, by the user terminal 2, a virtual ARS application 20 configured to control an output of the virtual ARS data from the virtual ARS data management server 50.

Preferably, in the step c), the user terminal 2 releases a communication connection.

Preferably, in the step d), an output of any one of the voice data and an output of the screen data matched with the voice data are synchronized with each other.

Preferably, the method further includes: after the step h), determining, by the user terminal 2, whether a key signal for requesting a counselor connection is applied; performing, by the user terminal 2, a phone call to the designated company terminal included in the virtual ARS data packet; and transmitting, by the user terminal 2, the virtual ARS key selection information of the user to phone number information of the designated company terminal included the virtual ARS data packet.

Preferably, the step h) further includes: determining, by the virtual ARS application installed in the user terminal 2, whether a signal communicating with a counselor is received; transmitting, by the virtual ARS application 20, a counselor connection request signal to the virtual ARS data management server 50; checking, by the virtual ARS data management server 50, a communication state of a plurality of ARS counselor terminals 70 to operate a waiting time for counseling; and communication connecting, by the virtual ARS data management server 50, the user terminal 2 to the available ARS counselor terminal 70 if it is determined that the waiting is less than a preset time.

Preferably, prior to starting the communication with the counselor or simultaneously with the communication, the virtual ARS data management server 50 collects a virtual ARS progress history (key selection information) and transmits the collected virtual ARS progress history to the ARS counselor terminal 70.

Preferably, the method further includes: requesting, by the virtual ARS data management server 50, information on whether virtual ARS of any company is in progress to the virtual ARS application 20 if it is determined that the waiting time is the preset time or more; transmitting, by the virtual ARS application 20, corresponding company information to the virtual ARS data management server 50; extracting, by the virtual ARS data management server 50, a designated counseling staff phone number of a predetermined corresponding company, and transmitting the extracted designated counseling staff phone number to the virtual ARS application 20; collecting, by the virtual ARS data management server 50, the virtual ARS progress history of the user and transmitting the collected virtual ARS progress history to the virtual ARS application 20 of the designated counseling staff terminal 72; and attempting, by the virtual ARS application 20 of the user terminal 2, a call connection to the designated counseling staff terminal 72 to perform communication.

### Advantageous Effects

In accordance with the system and method for controlling virtual ARS data using a mobile terminal according to the present invention, the company requiring the ARS may achieve the same effect as constructing the ARS system with no constructed ARS system, and dramatically reduce the communication traffic, as well as the customer may get more professional counseling when connecting to the counselor, such that the financial burden of the company is reduced to decrease prices of products, and thereby purchasing the products chiefly.

Further, according to the present invention, even when there is the ARS counselor, if the counseling waiting time is operated and thus is expected to be waited exceeding the preset time, the user may connect the user's counseling phone to the previously designated counseling staff terminal of the company providing the composite virtual ARS service, thereby minimizing the user's waiting time to increase the user convenience.

### DESCRIPTION OF DRAWINGS

FIG. 1 is a block diagram illustrating an entire configuration of a system for controlling virtual ARS data using a mobile terminal according to a first embodiment of the present invention.

FIG. 2 is a diagram illustrating a data construction state of a virtual ARS data management server included in the system for controlling virtual ARS data using a mobile terminal according to the first embodiment of the present invention.

FIG. 3 is a diagram illustrating screen composite virtual ARS data and a key selection state included in the system for controlling virtual ARS data using a mobile terminal according to the first embodiment of the present invention.

FIG. 4 is a diagram illustrating a screen composite virtual ARS service through the system for controlling virtual ARS data using a mobile terminal according to the first embodiment of the present invention.

FIG. 5 is a block diagram illustrating a configuration of a user terminal included in the system for controlling virtual ARS data using a mobile terminal according to the first embodiment of the present invention.

FIG. 6 is a flow chart illustrating a signal flow of the system for controlling virtual ARS data using a mobile terminal according to the first embodiment of the present invention.

FIG. 7 is a block diagram illustrating an entire configuration of a system for controlling virtual ARS data using a mobile terminal according to a second embodiment of the present invention.

FIG. 8 is a flow chart illustrating a signal flow of the system for controlling virtual ARS data using a mobile terminal according to the second embodiment of the present invention.

### BEST MODE

Hereinafter, embodiments of the present invention will be described in detail with reference to the accompanying drawings.

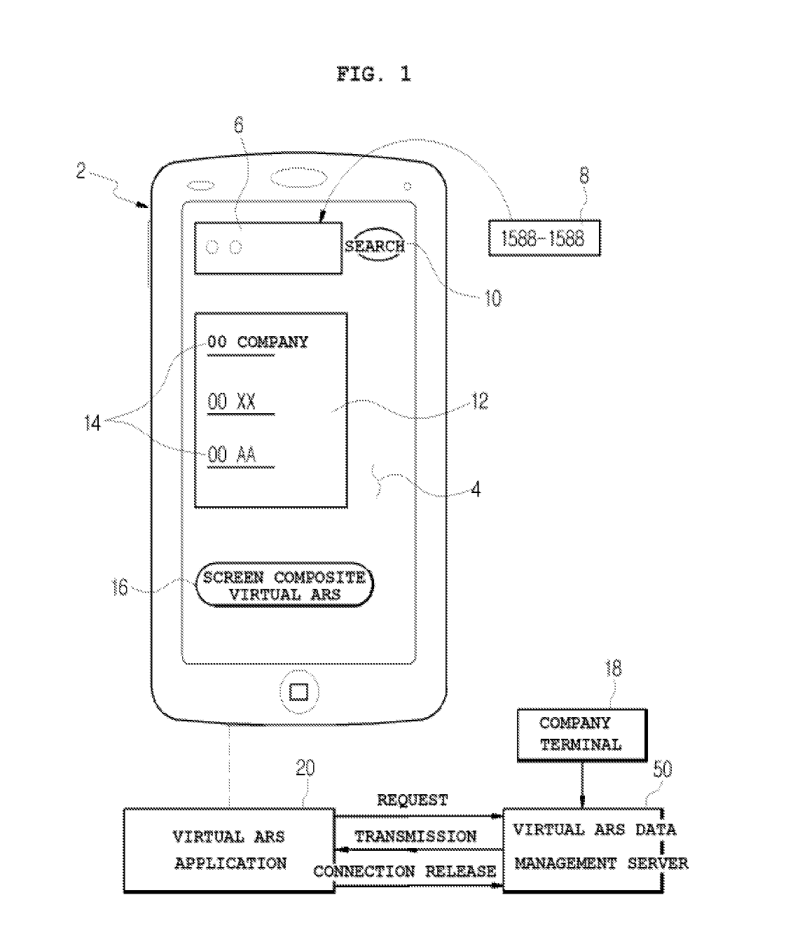

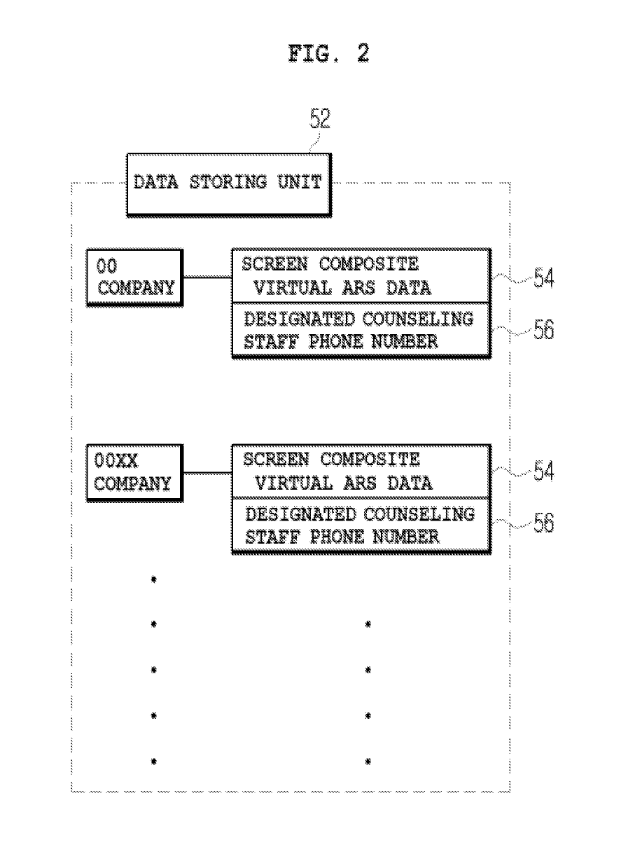

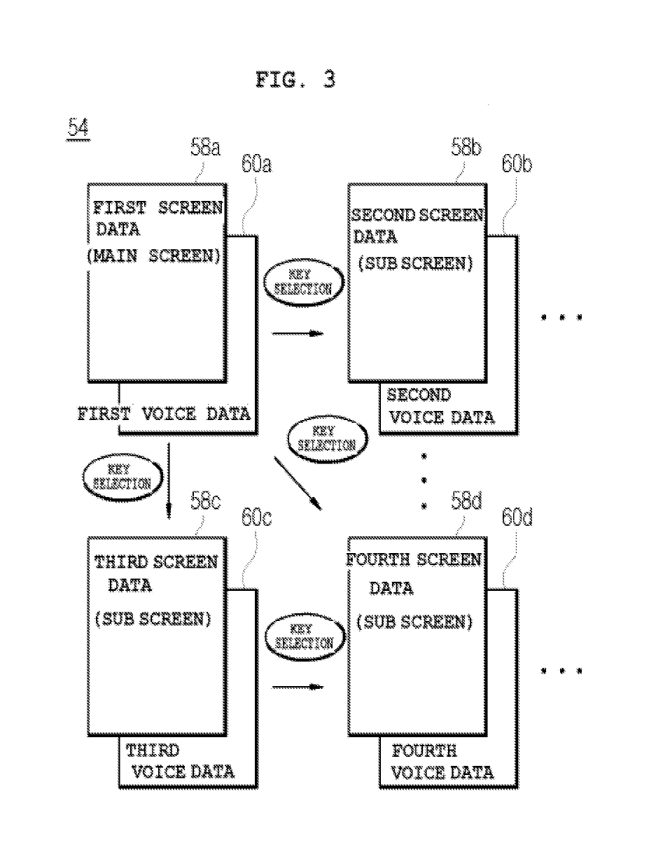

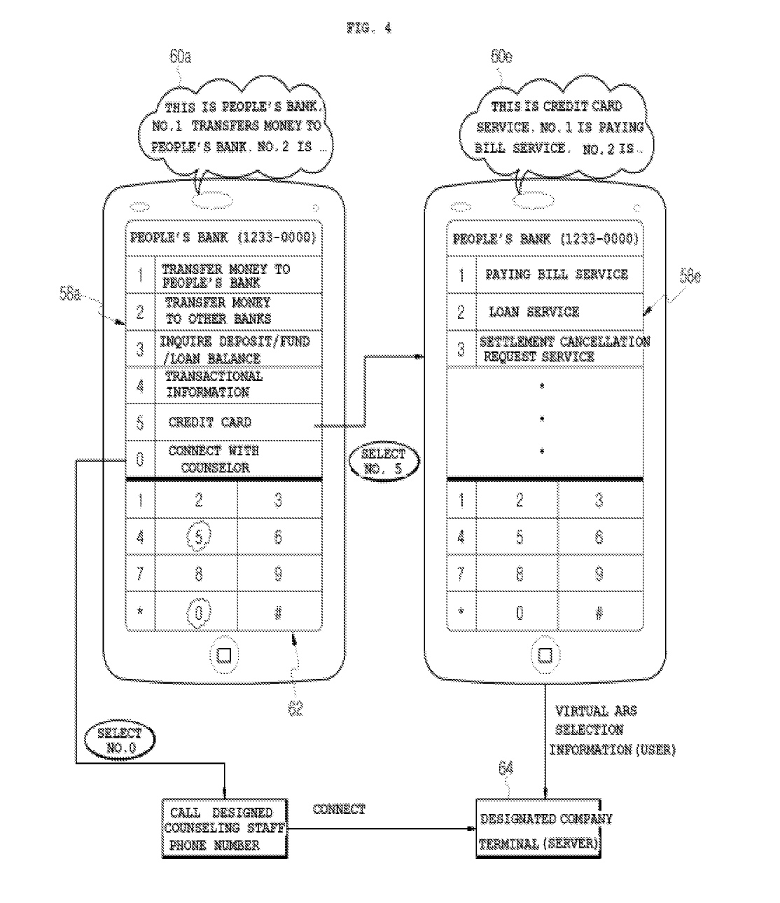

FIG. 1 is a block diagram illustrating an entire configuration of a system for controlling virtual ARS data using a mobile terminal according to the first embodiment of the present invention, FIG. 2 is a diagram illustrating a data construction state of a virtual ARS data management server included in the system for controlling virtual ARS data using a mobile terminal according to the first embodiment of the present invention, FIG. 3 is a diagram illustrating screen composite virtual ARS data and a key selection state included in the system for controlling virtual ARS data using a mobile terminal according to the first embodiment of the present invention, and FIG. 4 is a diagram illustrating a screen composite virtual ARS service through the system for controlling virtual ARS data using a mobile terminal according to the first embodiment of the present invention.

Referring to FIGS. 1 to 4, the system for controlling virtual ARS data using a mobile terminal according to the first embodiment of the present invention is a system capable of effectively reducing communication traffic without ARS construction costs or ARS counselors by downloading second-ranking screen data and voice data to a customer phone while matching each of the screen data with each of the voice data depending on a key selection of a customer to automatically output the screen data and the voice data, so as to provide an ARS service while a communication connection is released, and by allowing an application to automatically transmit ARS service information of the customer to a designated server or a designated terminal of the company when the ARS service performed by the customer's mobile terminal ends.

That is, the system for controlling virtual ARS data using a mobile terminal according to the first embodiment of the present invention is a system, in which virtual ARS packet data including voice and screen data are downloaded when a customer accesses a virtual ARS service of a specific company using a mobile application, the customer may use the ARS service while a communication connection is released, and ARS input information of the customer is automatically transmitted to the company when the service ends.

In more detail, the system for controlling virtual ARS data using a mobile terminal according to the first embodiment of the present invention is a system that may allow a company requiring ARS to achieve the same effect as constructing an ARS system with no constructed ARS system and dramatically reduce communication traffic, as well as the customer to get more professional counseling when connecting to the counselor, such that a financial burden of the company is reduced to decrease to prices of products, thereby purchasing the products chiefly.

To implement this, the system for controlling virtual ARS data using a mobile terminal according to the first embodiment of the present invention includes a user terminal 2 that generates a virtual ARS service request signal for a specific company to a virtual ARS data management server 50, receives screen composite virtual ARS data 54 combined to have a plurality of selection paths from the virtual ARS data management server 50 to automatically release a connection, and processes the virtual ARS service using a key selection signal of a user in an off line state.

Further, the system for controlling virtual ARS data using a mobile terminal according to the first embodiment of the present invention includes: a virtual ARS data management server 50 which receives and registers the screen composite virtual ARS data 54 from a plurality of company terminals 18, and extracts and downloads the screen composite virtual ARS data 54 of the company according to the request of the user terminal 2; and a designated company terminal (or a server) 64 which receives processing information of the virtual ARS service from the user terminal 2 when the virtual ARS services of each user ends.

More specifically, a screen composite virtual ARS related control operation processed by the user terminal 2 is mainly performed by a virtual ARS application 20 installed in the user terminal 2.

For this purpose, the user terminal 2 includes: a search window 6 configured to search for companies stored in the virtual ARS data management server 50; and the virtual ARS application 20 configured to output a screen composite virtual ARS service request button 16 for requesting a download of the screen composite virtual ARS data 54 of the company on a screen.

As illustrated in FIG. 1, a screen 4 output by a driving of the virtual ARS application 20 includes the search window 6 configured to search for registered companies that may provide the virtual ARS service. The search window 6 is provided with a search button 10 on a side portion thereof.

Further, the screen composite virtual ARS data 54 are classified and stored in the virtual ARS data management sever 50 to perform a search by a company name or a phone number 8 on the search window 6.

The screen 4 output by the driving of the virtual ARS application 20 is provided with a search result window 12. Therefore, result information 14 searched by an input of a search word is screen output on the search result window 12.

Any one company is selected from the result information 14 output on the search result window 12, and if the screen composite virtual ARS service request button 16 installed at a lower portion thereof is operated, a data request signal of the company is transmitted to the virtual ARS data management server 50.

Meanwhile, the screen composite virtual ARS data 54 are data which are received from the virtual ARS data management server 50, in which an output thereof is controlled by the driving of the virtual ARS application 20.

That is, the screen composite virtual ARS data 54 further includes: data in which a plurality of voice data and web screen data having the same content as the voice data are formed in a tree structure, wherein data to be output in a second ranking are connected to each other so as to be determined depending on a selection key signal of the user for preceding data; and phone number information of the designated company terminal.

Each company uploads the screen composite virtual ARS data 54 to the virtual ARS data management server 50 using a company terminal 18. The virtual ARS data management server 50 further includes a data storing unit 52 configured to store the screen composite virtual ARS data 54 for each company, data output path control information, and designated counseling staff phone number information 56.

More specifically, the screen composite virtual ARS data 54 are connected with the output path control information for various data so as to determine data to be output in a second ranking depending on a number key selected by a user while any one of the preceding data is output.

For example, as illustrated in FIGS. 3 and 4, when a user reads contents listed on the first screen data 58a (for example, a main screen 58a) by the output of the first screen data and generates any one of the number keys, screen data to be output in a second ranking by the number key are output from the first screen data 58a.

Describing in more detail with reference to FIG. 4, in order for a customer to read the contents listed on the virtual ARS service main screen (referred to as the first screen data 58a) of ‘people's bank’ and then get a service related to a ‘credit card’ that is a service of No. ‘5,’ if the customer selects No. 5 by a number key plate 62 of the user terminal 2, the virtual ARS application 20 of the user terminal 2 may determine what data are the second ranking data based on the data output path control information through the screen information and the number key selection signal.

Therefore, the virtual ARS application 20 extracts and outputs a sub screen 58e related to the ‘credit card’.

In this case, if the customer selects a key of ‘No. 0’ that is a counselor connection number on any screen output to the user terminal 2, the virtual ARS application 20 uses the pre-stored phone number information of the designated counseling staff to perform a phone call.

In this regard, the virtual ARS application 20 transmits the key selection information of the customer to the designated company terminal 64 with which the customer wants to consult, such that the staff may obtain the information on the customer before counseling or during counseling.

In addition, the screen composite virtual ARS data 54 includes a plurality of screen data 58a, 58b, 58c and . . . , and voice data 60a, 60b, 60c and . . . having the same content as each of the screen data 58a, 58b, 58c and . . . , such that the output through the screen and the voice output through a speaker are simultaneously executed.

In this case, when the screen data 58a is closed while any one screen data (for example, the first screen data 58a) is output to the user terminal 2, the output of the voice data (for example, the first voice data 60a) output simultaneously with the first screen data 58a also ends. That is, an output of the screen data 58a, 58b, 58c and . . . , and an output of the voice data 60a, 60b, 60c and . . . are synchronized with each other, which are included in the screen composite virtual ARS data 54.

Meanwhile, when progressing only the virtual ARS service without performing the voice communication with a counselor and then ending the service, the user terminal 2 of the customer is configured to temporarily store processing information of the virtual ARS service, and automatically transmit the processing information to the designated company terminal (or the server) when the virtual ARS service ends.

Therefore, a staff of the company may receive and process a change in customer information, a change and inquiry of the service, and request information. Thus, the same service as ARS may be progressed more economically with communication traffic being reduced.

In this case, a company performing the system for controlling virtual ARS data using a mobile terminal according to the first embodiment of the present invention may expect an additional profit and provide additional benefits to a customer. For this purpose, the screen composite virtual ARS data 54 may output a screen or a voice, additionally including separate advertisement data.

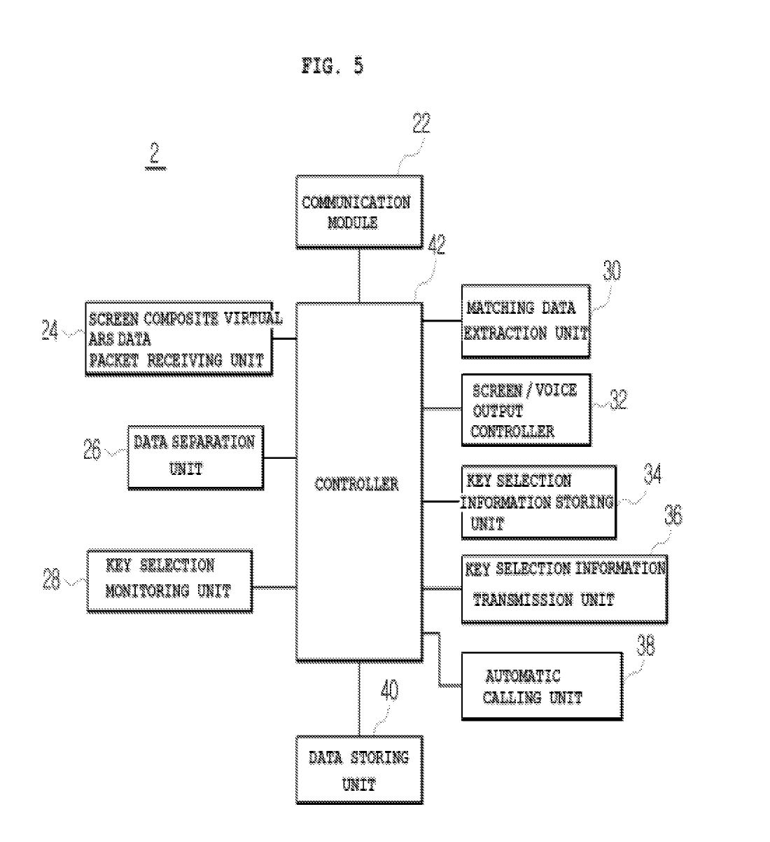

FIG. 5 is a block diagram illustrating a configuration of the user terminal included in the system for controlling virtual ARS data using a mobile terminal according to the first embodiment of the present invention.

Referring to FIG. 5, the user terminal 2 included in the system for controlling virtual ARS data using a mobile terminal according to the first embodiment of the present invention includes: a communication module 22 which communicates with the virtual ARS data management server 50 and the designated company terminal 64; a screen composite virtual ARS data packet receiving unit 24 which receives a screen composite virtual ARS data packet of a specific company from the virtual ARS data management server 50; and a data separation unit 26 which separates the received screen composite virtual ARS data packet into the voice data and the screen data, the data output path control information, and the phone number information of the designated company terminal.

Further, the user terminal 2 includes: a key selection monitoring unit 28 which monitors a key selection signal of a user when performing the virtual ARS service; a matching data extraction unit 30 which extracts second-ranking voice data matched with the key selection signal applied by the key selection monitoring unit 28 and the screen data connected to the voice data; a screen/voice output controller 32 which outputs and controls the voice data and the screen data extracted by the matching data extraction unit 30; a data storing unit 40 which stores the data received by the screen composite virtual ARS data packet receiving unit 24 and the data output path control information, and stores the key selection signal of the user for the data; and a controller 42 which requests and receives the screen composite virtual ARS data packet from the virtual ARS data management server 50, and controls the output of the screen composite virtual ARS data based on the data output path control information.

In this case, the user terminal 2 further includes: a key selection information storing unit 34 which stores the information matched with all the key selection signals received by the key selection monitoring unit 28; and a key selection information transmission unit 36 which transmits the key selection information to a previously designated company terminal 64.

Meanwhile, the user terminal 2 further includes an automatic calling unit 38 which automatically performs a phone call on a phone number of the previously designated company terminal 64, when the key selection monitoring unit 28 receives a key signal for requesting a counselor connection.

The function and operation of the system for controlling virtual ARS data using a mobile terminal according to the first embodiment of the present invention as described above will be described in detail with reference to the accompanying drawings.

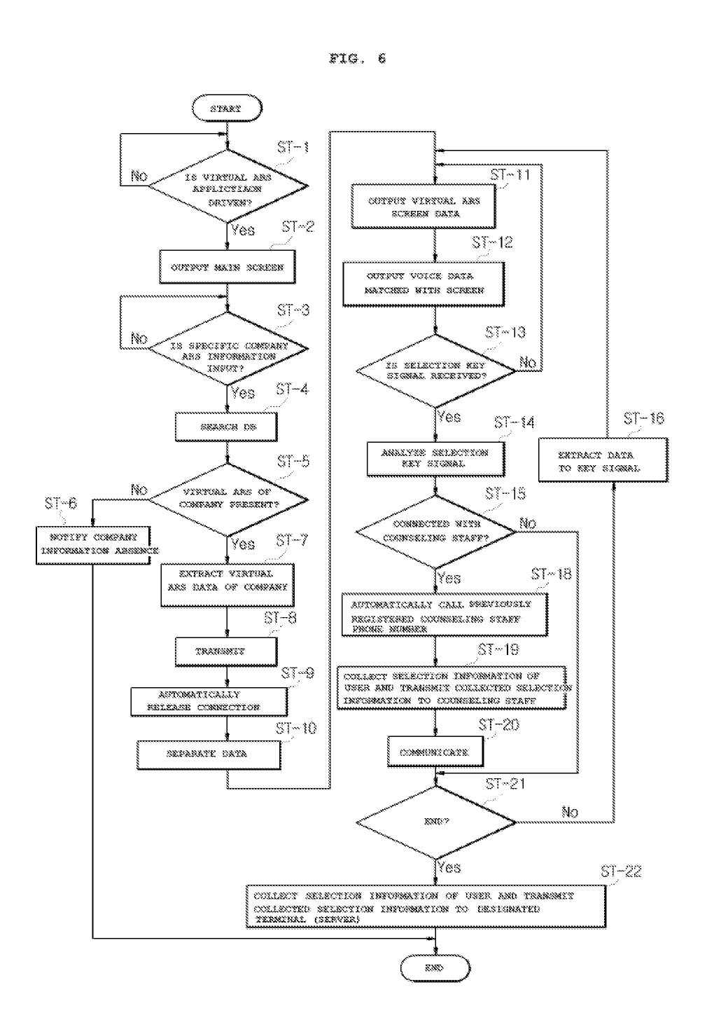

FIG. 6 is a flow chart illustrating a signal flow of the system for controlling virtual ARS data using a mobile terminal according to the first embodiment of the present invention.

First, the system for controlling virtual ARS data using a mobile terminal according to the first embodiment of the present invention allows the virtual ARS data management server 50 to upload different screen composite virtual ARS data 54 for each company using the company terminal 18. Then, the virtual ARS data management server 50 registers the screen composite virtual ARS data 54 therein.

In this case, in the state in which the user downloads the screen composite virtual ARS data 54 through the user terminal 2 at a time, as if the ARS service is progressed, the screen composite virtual ARS data 54 includes the plurality of screen data 58a, 58b, 58c and . . . , and the voice data 60a, 60b, 60c and . . . , which are selectively output through the screen and the speaker depending on the number key selected by the user, and the data output path control information for controlling the output path of the plurality of screen data 58a, 58b, 58c and . . . , and the voice data 60a, 60b, 60c and . . . depending on the number key signal input by the user, and the designated counseling staff phone number information 56.

Further, the data output path control is performed by the virtual ARS application 20. Therefore, the virtual ARS application 20 is downloaded from the virtual ARS data management server 50 to be installed in the user terminal 2.

In the state, the user operates the virtual ARS application 20 installed in the user terminal 2 to generate a search request signal for a specific company while the main screen including the search window is output.

Then, the search request signal is transmitted from the user terminal 2, and the virtual ARS data management server 50 receives the search request signal for the specific company from the user terminal 2.

Then, to determine whether there is the virtual ARS data for the company, the virtual ARS data management server 50 searches for the data storing unit 52 to extract the virtual ARS data packet of the company.

As the search result by the virtual ARS data management server 50, if it is determined that the company is not a virtual ARS service registration company, and thus the virtual ARS data are absent, the virtual ARS data management server 50 notifies the user terminal 2 of the information absent state of the company.

On the other hand, if it is determined that the virtual ARS data of the company are present, the virtual ARS data management server 50 transmits the virtual ARS data packet to the user terminal 2, and automatically releases the communication connection to the user terminal 2.

That is, one of the technical features of the virtual ARS data control system using the mobile terminal according to the embodiment of the present invention is that as if the user terminal 2 progresses the ARS service with the communication connection being released, the user terminal 2 may progress the virtual ARS service in an offline state.

Preferably, the release of the communication connection is also performed by the virtual ARS data management server 50 or by the user terminal 2.

Therefore, with the communication connection being released, the virtual ARS application 20 installed in the user terminal 2 outputs the screen data and the voice data that are first output data of the virtual ARS data of the company through the data output path control information included in the received data packet.

In this case, any one voice data and the screen data matched with the voice data are data having the output synchronized with each other. Therefore, if the screen data are passed to page 2, the voice data are also connected to the output path so that the same voice file as page 2 is reproduced, and if the page output on the screen is closed, the reproduction of the reproduced voice data ends.

In the state, if the user terminal 2 receives a specific key selection signal, accurately, the virtual ARS application 20 rather than the user terminal 2 extracts and outputs the voice data and the screen data matched with the key selection signal depending on the data output path control information.

Therefore, the outputs of the plurality of voice data and screen data having the tree structure and the selection of the number key of the user are repeatedly performed.

In this case, the virtual ARS application 20 temporarily stores the key selection information of the user.

Further, the virtual ARS application 20 determines whether a virtual ARS service ending signal is applied.

If it is determined that the virtual ARS service ending signal is applied, the user terminal 2 transmits the key selection information of the user to the designated company terminal 64 included in the virtual ARS data packet to perform information processing as the service selection information selected by the user.

For example, when the user tries to update the information on the address change through the virtual ARS of the company, the virtual ARS application 20 transmits the update request information on new address information to the previously designated company terminal 64, and a staff of the company possessing the phone may perform address change processing of the user through a separate company PC (not illustrated), and may also perform the automatic update if the phone is connected to the company PC so as to automatically update the information of the designated company terminal 64.

However, a description for the data automatic update between the mobile terminal and the PC is not a gist of the present invention, and therefore will not be described in detail.

Meanwhile, when the user wants the voice communication with a counselor, the virtual ARS application 20 installed in the user terminal 2 determines whether the key signal for connection with the counselor is applied.

If the user applies the selection signal wanting the voice communication with the counselor, the virtual ARS application 20 of the user terminal 2 perform a phone call to the designated company terminal included in the virtual ARS data packet.

In this case, the user terminal 2 performing the virtual ARS operation in the offline state executes the communication connection for the voice communication with the designated company terminal, and the virtual ARS application 20 applies an automatic phone call signal to the known communication circuit to perform the automatic calling.

In this regard, the virtual ARS application 20 of the user terminal 2 transmits the virtual ARS key selection information of the user that is temporarily stored as the phone number information of the designated company terminal included in the virtual ARS data packet.

Then, the counselor may quickly understand personal information of the user trying voice communication and quickly understand what service the user previously performs an attempt to receive through the virtual ARS, such that the counselor may perform the quick counseling.

Hereinafter, a system for controlling virtual ARS data using a mobile terminal according to a second embodiment of the present invention will be described with reference to the accompanying drawings.

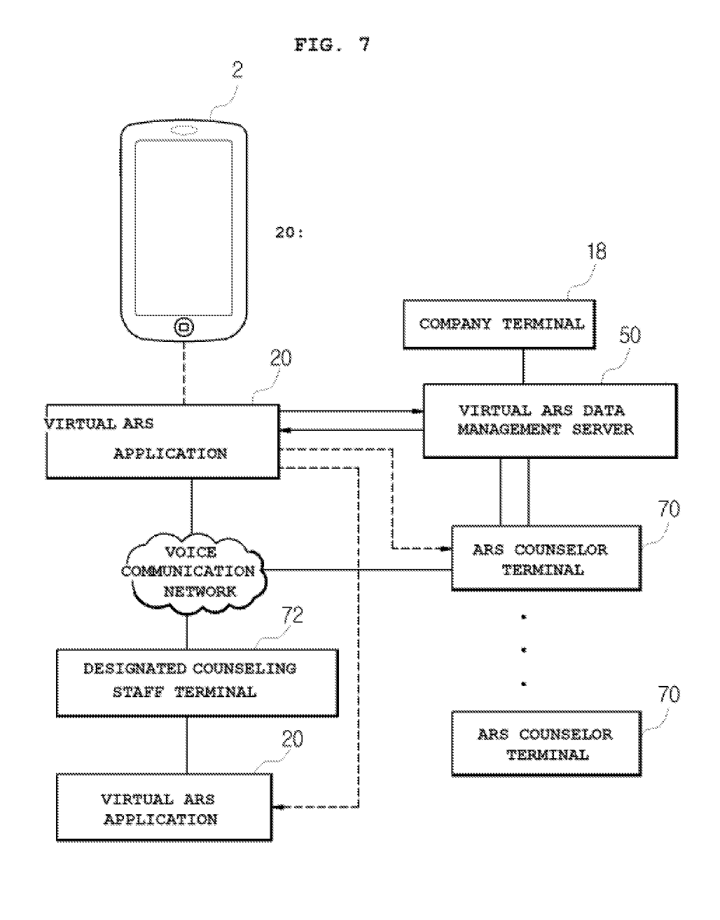

FIG. 7 is a block diagram illustrating an entire configuration of the system for controlling virtual ARS data using a mobile terminal according to the second embodiment of the present invention.

Referring to FIG. 7, the system for controlling virtual ARS data using a mobile terminal according to the second embodiment of the present invention is a system that effectively reduces a waiting time of a user and reduces traffic of an ARS server for waiting counseling by allowing a server to automatically operate a counseling waiting time when a user generates a key signal for connecting to a counselor while a screen composite virtual ARS service is progressed, transmit phone number information of a specific staff terminal of a company if it is determined that the waiting time is a preset time or more, and transmit virtual ARS progress history information to a counselor terminal or a designated counseling staff terminal to be called, thus to generate an automatic call attempt.

The system for controlling virtual ARS data using a mobile terminal according to the second embodiment of the present invention includes a virtual ARS data management server 50 which is connected to a plurality of ARS counselor terminals 70 to check absence and presence of communication and operates the counseling waiting time.

Further, the virtual ARS data management server 50 is connected to the plurality of ARS counselor terminals 70 to check absence and presence of communication to operate the counseling waiting time, and if the waiting time is a preset time or more, and is configured to request information on whether the composite virtual ARS service of any company is progressed to the user terminal 2, and automatically transmit phone number information of a designated counseling staff terminal 72 of the company to the user terminal 2.

Further, when a user performs voice counseling with an ARS counselor or designated counseling staffs for each company, the virtual ARS data management server 50 is configured to transmit composite virtual ARS service progress history information of a specific company progressed by the user to the ARS counselor terminal 70 or the designated counseling staff terminal 72.

The function and operation of the system for controlling virtual ARS data using a mobile terminal according to the second embodiment of the present invention having the above-described configuration will be described in detail with reference to the accompanying drawings.

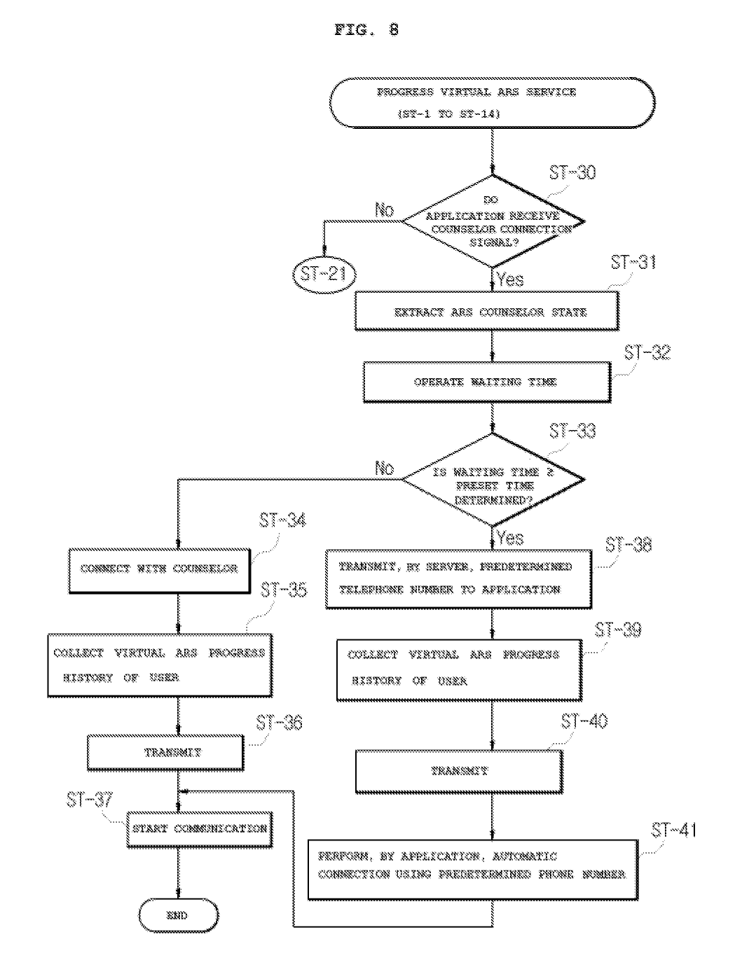

FIG. 8 is a flow chart illustrating a signal flow of the system for controlling virtual ARS data using a mobile terminal according to the second embodiment of the present invention.

In connection with this, FIG. 8 illustrates processes ST-1 to ST-14 that are processes of progressing a virtual ARS in the flow chart of FIG. 7, and describes a processing process when the user clicks a button wanting the voice communication with the counselor through the virtual ARS application 20.

First, if the user operates the virtual ARS application 20 to generate a signal for connection with a counselor, the virtual ARS application 20 transmits a counselor connection request signal to the virtual ARS data management server 50.

Then, the virtual ARS data management server 50 checks the communication state of the plurality of ARS counselor terminals 70 to extract the operation environment of the ARS counselor terminal 70.

Further, the virtual ARS data management server 50 operates a waiting time for counseling with an ARS counselor. That is, at ordinary times, the virtual ARS data management server 50 checks the communication start of the ARS counselor terminal 70 to the communication end thereof with being connected to the ARS counselor terminal 70, such that an average counseling time is stored in advance. By using the stored average counseling time, even though all the counselors are counseling currently, it is possible to operate how many counselors can counsel with customers after the customers wait for several minutes on average.

In this case, if it is expected as the operation result of the virtual ARS data management server 50 that the waiting time is less than the preset time, the virtual ARS data management server 50 allows the user to wait for counsel and performs the communication connection to the user terminal 2 if there is an available counselor after the waiting time.

At the same time or before the communication connection, the virtual ARS data management server 50 collects the virtual ARS progress history of the user and transmits the collected virtual ARS progress history to the counselor terminal 70.

That is, by transmitting the histories selected by the user through the virtual ARS application 20 before communicating with the ARS counselor and output as the screen data or the voice data to the counselor terminal, the counselor may quickly understand and predict the selection conditions or the requirements of the user.

For example, even though a separate ARS system is not constructed, a counselor may quickly know information such as ‘credit card losing report,’ ‘the date of birth,’ ‘whether a reissue of the credit card is applied,’ and ‘position where a credit card is lost is domestic’ that are the virtual ARS progress history of the user.

In this state, communication with the counselor may start.

On the other hand, as the operation result of the virtual ARS data management server 50, if it is determined that the waiting time is the preset time or more, the virtual ARS data management server 50 requests information on whether the virtual ARS of any company is in progress to the virtual ARS application 20.

As a result, if the virtual ARS application 20 transmits the company information to the virtual ARS data management server 50, the virtual ARS data management server 50 extracts the designated counseling staff phone number of the previously designated company, and transmits the extracted designated counseling staff phone number to the virtual ARS application 20.

In this case, the phone number information includes automatic communication button control information.

Simultaneously, the virtual ARS data management server 50 collects the virtual ARS progress history and transmits the collected the virtual ARS progress history to the virtual ARS application 20 of the designated counseling staff terminal 72.

Then, the virtual ARS application 20 of the user terminal 2 attempts a call connection to the designated counseling staff terminal 72 to perform communication with the counselor.

In this case, the user terminal 2 and the designated counseling staff terminal 72 may perform the voice communication through a voice communication network, and may also perform the voice communication through a data communication network between the virtual ARS application 20 of the user terminal 2 and the virtual ARS application 20 of the designated counseling staff terminal 72.

In the latter case, separate voice communication cost does not occur.

Therefore, even though the ARS counselor who may perform the voice counseling is constructed, the system for controlling virtual ARS data using a mobile terminal according to the second embodiment of the present invention does not need to construct an ARS apparatus for high-cost phone connection processing and therefore is economical. If it is determined that the waiting time is long by checking the counseling possible time of the ARS counselor, it is possible to perform the automatic connection to the designated counseling staff terminal of the previously designated company to perform the customer counseling, and quickly understand the customer state for counseling by allowing the user to transmit the virtual ARS information previously performed through the application to the counselor. Thereby, it is possible to effectively reduce the waiting time of the customer for the counselor connection and maximize the customer convenience.

Meanwhile, the system and method for controlling ARS data using a mobile terminal in accordance with the exemplary embodiment of the present invention are not limited to the above-described embodiments, but may be variously changed without departing from the technical subjects thereof.

### DESCRIPTION OF REFERENCE NUMERALS

a. 2: user terminal
b. 18: company terminal
c. 20: virtual ARS application
d. 50: virtual ARS data management server
e. 64: designated company terminal

1. A system for controlling automatic response service (ARS) data using a mobile terminal, comprising:
a user terminal configured to generate a virtual ARS service request signal for a specific company to a virtual ARS data management server, receive screen composite virtual ARS data combined to have a plurality of selection paths from the virtual ARS data management server to automatically release a connection, and process the virtual ARS service using a key selection signal of a user in an off line state;
the virtual ARS data management server configured to receive and register the screen composite virtual ARS data from a plurality of company terminals, and extract and download the screen composite virtual ARS data of the company according to a request of the user terminal; and
a designated company terminal (or a server) configured to receive processing information of the virtual ARS service from the user terminal when the virtual ARS services of each user ends.

2. The system of claim 1, wherein the screen composite virtual ARS data further includes:
data in which a plurality of voice data and web screen data having the same content as the voice data are formed in a tree structure, wherein data to be output in a second ranking are connected to each other so as to be determined depending on a selection key signal of the user for preceding data; and
phone number information of the designated company terminal.

3. The system of claim 1, wherein the user terminal is configured to temporarily store processing information of the virtual ARS service, and automatically transmit the processing information to the designated company terminal (or the server) when the virtual ARS service ends.

4. The system of claim 1, wherein the user terminal includes: a search window configured to search for companies stored in the virtual ARS data management server; and a virtual ARS application configured to output a screen composite virtual ARS service request button for requesting a download of the screen composite virtual ARS data of the company on a screen.

5. The system of claim 1, wherein the virtual ARS data management server further includes:
a data storing unit configured to store the screen composite virtual ARS data for each company, data output path control information, and designated counseling staff phone number information.

6. The system of claim 1, wherein an output of voice data and an output of screen data having the same content as the voice data, which are included in the screen composite virtual ARS data, are synchronized with each other.

7. (canceled)

8. The system of claim 1, wherein the virtual ARS data management server is connected to a plurality of ARS counselor terminals to check presence and absence of communication and operate a counseling waiting time.

9. The system of claim 1, wherein the virtual ARS data management server is connected to a plurality of ARS counselor terminals to check presence and absence of communication to operate a counseling waiting time, and if the waiting time is a preset time or more, the virtual ARS data management server is configured to request information on whether the composite virtual ARS service of any company is progressed to the user terminal and automatically transmit phone number information of a designated counseling staff terminal of the company to the user terminal.

10. The system of claim 1, wherein when the user performs voice counseling with an ARS counselor or designated counseling staffs for each company, the virtual ARS data management server is configured to transmit composite virtual ARS service progress history information of a specific company progressed by the user to an ARS counselor terminal or a designated counseling staff terminal.

11. The system of claim 1, wherein the user terminal includes:
a communication module configured to communicate with the virtual ARS data management server and the designated company terminal;
a screen composite virtual ARS data packet receiving unit configured to receive a screen composite virtual ARS data packet of a specific company from the virtual ARS data management server;
a data separation unit configured to separate the received screen composite virtual ARS data packet into the voice data and the screen data, data output path control information, and phone number information of the designated company terminal;
a key selection monitoring unit configured to monitor a key selection signal of the user when performing the virtual ARS service;
a matching data extraction unit configured to extract second-ranking voice data matched with the key selection signal applied by the key selection monitoring unit and the screen data connected to the voice data;
a screen/voice output controller configured to output and control the voice data and the screen data extracted by the matching data extraction unit;
a data storing unit configured to store the data received by the screen composite virtual ARS data packet receiving unit and the data output path control information, and store a key selection signal of the user for the data; and
a controller configured to request and receive the screen composite virtual ARS data packet of the specific company from the virtual ARS data management server, and control the output of the screen composite virtual ARS data based on the data output path control information.

12. The system of claim 11, further comprising:
a key selection information storing unit configured to store the information matched with all the key selection signals received by the key selection monitoring unit; and
a key selection information transmission unit configured to transmit the key selection information to the previously designated company terminal.

13. The system of claim 11, further comprising: an automatic calling unit configured to automatically perform a phone call on a phone number of the previously designated company terminal, when the key selection monitoring unit receives a key signal for requesting a counselor connection.

14. A method for controlling virtual automatic response service (ARS) data using a mobile terminal, comprising the steps of:
a) receiving, by a virtual ARS data management server, a search request signal for a specific company from a user terminal;
b) extracting, by the virtual ARS data management server, a virtual ARS data packet of the company;
c) transmitting, by the virtual ARS data management server, the virtual ARS data packet to the user terminal, and automatically releasing a communication connection to the user terminal;
d) outputting voice data and screen data included in the virtual ARS data packet;
e) receiving, by the user terminal, a specific key selection signal;
f) extracting, by the user terminal, the voice data and the screen data matched with the key selection signal;
g) determining whether a virtual ARS service ending signal is applied; and
h) transmitting, by the user terminal, key selection information of the user to a designated company terminal included in the virtual ARS data packet when receiving the virtual ARS service ending signal or a counselor connection signal.

15. The method of claim 14, further comprising: prior to the step a), downloading and installing, by the user terminal, a virtual ARS application configured to control an output of the virtual ARS data from the virtual ARS data management server.

16. The method of claim 14, wherein in the step c), the user terminal releases a communication connection.

17. The method of claim 14, wherein in the step d), an output of any one of the voice data and an output of the screen data matched with the voice data are synchronized with each other.

18. The method of claim 14, further comprising: after the step h),
determining, by the user terminal, whether a key signal for requesting a counselor connection is applied;
performing, by the user terminal, a phone call to the designated company terminal included in the virtual ARS data packet; and
transmitting, by the user terminal, the virtual ARS key selection information of the user to phone number information of the designated company terminal included the virtual ARS data packet.

19. The method of claim 14, wherein the step h) further includes:
determining, by the virtual ARS application installed in the user terminal, whether a signal communicating with a counselor is received;
transmitting, by the virtual ARS application, a counselor connection request signal to the virtual ARS data management server;
checking, by the virtual ARS data management server, a communication state of a plurality of ARS counselor terminals to operate a waiting time for counseling; and
communication connecting, by the virtual ARS data management server, the user terminal to the available ARS counselor terminal if it is determined that the waiting is less than a preset time.

20. The method of claim 19, wherein prior to starting the communication with the counselor or simultaneously with the communication, the virtual ARS data management server collects a virtual ARS progress history (key selection information) and transmits the collected virtual ARS progress history to the ARS counselor terminal.

21. The method of claim 19, further comprising:
requesting, by the virtual ARS data management server, information on whether virtual ARS of any company is in progress to the virtual ARS application if it is determined that the waiting time is the preset time or more;
transmitting, by the virtual ARS application, corresponding company information to the virtual ARS data management server;
extracting, by the virtual ARS data management server, a designated counseling staff phone number of a predetermined corresponding company, and transmitting the extracted designated counseling staff phone number to the virtual ARS application;
collecting, by the virtual ARS data management server, the virtual ARS progress history of the user and transmitting the collected virtual ARS progress history to the virtual ARS application of the designated counseling staff terminal; and
attempting, by the virtual ARS application of the user terminal, a call connection to the designated counseling staff terminal to perform communication.

22. (canceled)
